(19) United States
(12) Patent Application Publication
(10) Pub. No.: US 2011/0089728 A1
(43) Pub. Date: Apr. 21, 2011

(54) Child car seat

(75) Inventor: Jan-Stefan Wuerstl, Regnitzlosau (DE)

(73) Assignee: Curt Wuerstl Vermoegensverwaltungs-GmbH & Co. KG, Hof (DE)

(21) Appl. No.: 12/925,027

(22) Filed: Oct. 12, 2010

(30) Foreign Application Priority Data
Oct. 19, 2009 (DE) 20 2009 013 376.1

(51) Int. Cl. B60N 2/42

(52) U.S. Cl. 297/216.11

(57) ABSTRACT

A child car seat has at least one seat part with side walls forming armrests and an impact cushion, which is insertable between the side walls of the seat part and/or placeable thereon and is supported at the side walls. The impact cushion ends in front of the child sitting in the child car seat and has a transversely extending recess for insertion of at least one transverse belt. There are fixing points provided at both sides, at the vehicle seat and/or the bodywork for fastening the car seat to the automobile via fasteners. There are also fastening points provided at the two side walls of the seat part and/or at the backrest part, for fastening the fasteners and the transverse belt to the seat part. The fastening points can be mounted to be rotatable, or the fasteners, lock elements, metal plates or other retaining means can be rotatably mounted at the fastening points, so that an optimal cable line of the tightened belt sections automatically arises. A decoupled introduction of force into the fastening belts for the seat and into belts for retaining the impact cushion is achieved.

### CROSS REFERENCE TO RELATED APPLICATIONS

Applicant claims priority under 35 U.S.C. §119 of German Application No. 20 2009 013 376.1 filed Oct. 19, 2009.

### BACKGROUND OF THE INVENTION

The invention relates to a child car seat comprising at least one seat part with side walls forming armrests and an impact cushion, which is insertable between the side walls of the seat part and/or placeable thereon and is supported at the side walls and which ends in front of the child sitting in the child car seat and has a transversely extending recess for insertion of at least one transverse belt

A child car seat this type is known from, for example, German Patent No. DE 295 10 641 U1. Fixing of the child car seat on a motor vehicle seat is carried out by a restraining system which belongs to the vehicle and which includes at least a lap part, but particularly also a diagonal part. The seat part has flanking lateral boundaries in the form of armrests which together with the side wall form a channel. Lying between the armrests is an impact cushion with a horizontal channel, which extends over its width and is open towards the front, for insertion of the lap part of the belt. In one embodiment, the impact cushion, for securing thereof, engages under the armrests, but can also rest by the lower edges of its side ends on the side edges of the seat. In a further embodiment, the impact cushion is guided by its side ends in a dovetail manner between the armrests and the side edges of the seat. In addition, the impact cushion can be guided at the seat part to be displaceable in the seat depth direction. The impact cushion itself can be a plastics material part and substantially of U-shape, so that in the case of a collision or a crash the child sitting in the child seat impacts onto the impact cushion. The upper part is pressed down against the lower part by the transverse channel, in which case it is not impossible for the child to fall out of the seat if the depth of the channel forming the armrest of the side wall has not been constructed with sufficient depth, since this would have to be matched to the size of a small child, which, however, is not possible in terms of production. The channel will thus always have a depth which corresponds with the average size of the child to be kept secured in such a seat. In the case of a crash, the displacement travel of the impact cushion is limited by the transverse or lap belt section and the diagonal belt section.

Impact cushions which can similarly be placed on the side walls of a seat part and which are arranged to be displaceable thereon are additionally known from German Patent No. DE 35 17 841 A1, European Patent No. EP 0 170 733 A1 and German Patent No. DE 79 07 643 U1. The lap belt sections of a three-point belt in that case always either run through in a transversely extending, groove-shaped recess in the impact cushion or bear against the outer side. The diagonal section of a three-point belt runs diagonally over these side cheeks of the child seat or is guided in guides or is held secured at the end faces of the side walls by guides or clamps.

The impact cushion is a component of a restraint system for children seated in child car seats and is employed in numerous variants of construction. Such an impact cushion can also be used with a seat part, which elevates the sitting position of the child, without a backrest, the seat part being placed on the vehicle seat and held by means of the existing three-point belt of the vehicle seat, in that the lap section of the three-point belt is drawn through a recess or channel of the impact cushion and the lock tongue is inserted into the lock at the vehicle seat. The impact cushion can rest on the upper limbs of the child or a separate child seat or be supported directly by appropriate projections on the vehicle seat. In the case of a frontal impact of the vehicle, the upper body of the child impacts on the surface of the impact cushion. Since it is provided with a foam or upholstered insert, this results in strong damping and does not lead to injury of the child. However, the known impact cushions have the disadvantage that, as a consequence of their horizontally displaceable position, when acceleration occurs due to a collision they are similarly forcibly moved forwards and accordingly the spacing from the child to be protected can increase.

In all known child seat constructions with impact cushions, the impact cushion is fixed to the child car seat by the lap belt of a three-point safety belt belonging to the vehicle or by a separate transverse belt. The seat itself can also be fastened to an underneath part which is provided with an ISOFIX (ISO 13216) retaining means, fastenable to ISOFIX fastening points at the seat, namely at transverse pins. In the case of fastening by means of a three-point belt belonging to a vehicle, the child is additionally restrained in the child seat by the diagonal shoulder strap or else the diagonal strap is arranged to run behind the seat.

It has proved that for secure retention of a child seat, an underneath part able to be plugged to the inner ISOFIX retaining means is necessary. If the child seat is held only by the belt and, in particular, together with the impact or rebound cushion, it is not impossible that the child car seat shifts or turns on the vehicle seat. This occurs even when the impact cushion is guided by means of lateral guides in slots of the side walls of a seat part and the transverse belt is introduced into the recess of the impact cushion. The introduction of force into the belt is—by comparison with securing by ISOFIX retaining means—less favorable when the child seat is, for example, securely restrained by a three-point belt. This can also lead to, for example, slight turning of the seat in the event of a crash. On the other hand, fastening by means of belts offers an advantage, since the existing lock systems of the three-point belt can be used for securing.

### SUMMARY OF THE INVENTION

It is therefore an object of the invention to enable a simple seat mounting and a simple handling of the seat and of making possible a fastening, which is secure by comparison with the ISOFIX retaining means, of a child car seat to a motor vehicle.

The object is fulfilled by construction of a child car seat comprising at least one seat part with side walls forming armrests and an impact cushion, which is insertable between the side walls of the seat part and/or placeable thereon and is supported at the side walls and which ends in front of the child sitting in the child car seat and has a transversely extending recess for insertion of at least one transverse belt

The car seat according to the invention is distinguished by the fact that, for fixing the child car seat to the motor vehicle seat, there are fixing points which are provided at both sides, at the vehicle seat and/or the bodywork, for fixing fastening means connected to the child car seat via fastening points mounted on the two side walls of the seat part and/or backrest part. There are also fastening points for fixing of the transverse belt at the side walls. The fastening points can be mounted to be rotatable or the fastening means, lock elements, metal plates or other retaining means can be rotatably mounted at the fastening points, so that an optimal cable line of the tightened belt sections automatically arises. A decoupled introduction of force on the one hand into the fastening belts for the seat and on the other into belts for retaining the impact cushion is achieved by the invention.

In departure from the prior art, the impact cushion is thus always retained by an own transverse belt secured to the seat part of the child car seat, which by contrast with the prior art is not fastenable to the ISOFIX points of the vehicle seat or to the locks of the safety belt belonging to the vehicle, but is fastened to fastening points at the side walls of the seat part. In the simplest form, the fastening can take place by way of, for example, press button connectors or flat zip fastener connectors, wherein one part is fastened to the side wall of the seat, for example by gluing or welding, and the other part to the belt itself, for example by gluing, stitching or welding. Such fastening means are sufficient for the transmission of force, since in the event of a crash the entire force of the child seat no longer acts on the transverse belt, but only the force which emanates from the impact cushion when the child impacts. However, the transverse belt can also be provided at its end with lock elements, for example elements having lock tongues. In this case it is recommended to fasten the lock elements, into which these lock tongues can be inserted, to the fastening points at the child car seat. The lock tongues can be formed integrally. The belt can also be sewn to such, for which purpose the lock plate with the lock tongue has a receiving gap for the belt. The lock elements can be of the kind known from the lock systems of conventional safety belts.

Such a lock element can also be combined with a second one, which extends downwardly relative to the fastening point. A lock counter-element at a safety belt can be plugged into this lock element, which belt has the form of a short belt for fastening of the child car seat to the vehicle seat and is connectable by its lock element or plug-on securing element, which is provided at the second end, with the lock counter-element at the vehicle seat or at the bodywork or with the transverse pin of an ISOFIX connector. This depends on the respective construction of the lock element or plug-on securing element. It will be obvious that for adaptation to different vehicle dimensions, the safety belts should be constructed to be adjustable. The transverse belt can, thereagainst, have a defined capability when no depth adjustments of the impact cushion are provided. If this is the case, an adjustment possibility should also be provided at the transverse belt. In every instance an adjustment possibility of the belt length is to be provided with respect to the belt serving for securing the child seat to the vehicle seat.

Instead of a single fastening point at the child car seat, which, for example, can be realized when lock elements are used by a rivet connection or screw connection or by way of a rotatably mounted pin, separate fastening points for the transverse belt and for the securing belt can also be provided. These latter fastening points can also be provided in the lower region of the backrest or at the backrest of the child car seat. In every case, a distributed introduction of force in the event of a crash results by virtue of the construction according to the invention. It is apparent that the vehicle safety belt is virtually no longer needed for fastening of the child seat and that nevertheless a more secure retention of the child seat in the vehicle seat is given and in the event of a crash, the impact cushion introduces the resulting forces into the seat part by way of the transverse belt.

It has proved desirable to provide the fastening points for the transverse belt in the rearward region below the seat surface of the child car seat. Equally, the fastening points for the securing belt can also be provided at this location if two separate fastening points are provided. The fastening points for the securing belt can, however, also be provided in the lower region of the backrest. This can be realised by securing pins which are introduced into indentations of the side walls and which are constructed as, for example, rivet pins or screw bolts, or by a transverse rod which is plugged through holes in the seat part, so that the forces can be distributed to the entire seat part. By virtue of the fastening belts or safety belts belonging to the seat on the one hand and the transverse belt on the other hand it is apparent that simple mounting is made possible, since the transverse belt of the impact cushion can be separately released and locked and the seat is securely held independently thereof in its position by the safety belts. The safety belts, which are provided as fastening means, can obviously also be replaced by, for example, adjustable telescopic rods, which can take over the retaining function. However, it is easier in terms of handling to provide such securing belts as fastening means. Known deflecting and clamping means can be used for shortening or lengthening the transverse belt or the securing belt or also other setting means so as to be able to adapt the belt lengths to the respective requirements.

If the securing belt as fastening means is to be fastened to a transverse pin of an ISOFIX retaining means, plug-on securing means having a U-shaped introduction slot with catch hooks are fastened to the belt ends. When the U-shaped introduction slot is placed on the transverse pin, the catch hooks engage behind the same and secure the assembly. The plug-on securing element can have an unlocking button in order to be able to release the catch hooks again. If a lock element has a lock tongue with a recess, then this is introducible in known manner into a lock counter-element with an entry slot and is held therein by a detent part which detents in the recess. This detent part can be actuated indirectly by way of a button or also directly via a passage in a wall of the lock housing. By pressing, the detent part slides out of the recess and the connection can be released again.

In the simplest construction, a small metal plate or a retainer with such a plate can also be fastened or rotatably mounted at the fastening point, the retainer having transverse slots above and/or below the fastening point for reception of at least one belt as fastening means or of the transverse belt. These can be permanently fastened to the metal plate by stitching of the ends of the belt to form a unit therewith. Such a metal plate has, for fixing at the fastening point, a bore and is plugged by that onto a fastening pin.

As securing means against withdrawal, such as a screw head or rivet head or other securing element, can be plugged onto this pin. If the fastening is undertaken at an ISOFIX retaining means, use can also be made of a fastening belt with a spring-clip hook or a similar hook with withdrawal securing means, which is fixed at one end at the fastening point and can be hung at the other end by the hook on the transverse pin of the ISOFIX retaining means.

The fastening point can in principle also be realized by a bracket at the side wall. The bracket forms, together with the side wall, a gap through which the transverse belt and/or the fastening means, which can similarly be a belt, can be drawn. Attached to the transverse belt and/or to the fastening means is a retraction securing element, which prevents withdrawal of the end of the transverse belt or of the fastening means led through the gap. The retraction securing element can be, for example, a lock element of a belt, which is larger than the gap. A lock counter-element of the other belt can then be plugged into the lock element. In the simplest embodiment, the bracket can also be used only for the purpose of forming an additional guide for the transverse belt, which is fastenable to the transverse pin of the ISOFIX retaining means by way of plug-on securing means. However, the bracket can also be used for the purpose of being able to fasten thereto, or by way of an alternatively provided eye, belts with spring-clip hooks. These are fastened in known manner to the belts by drawing the end of the belt through the transverse slot and stitching it to the belt or, however, by being held by means of a clamping device of a length adjuster at the hook.

In order to be able to fix the impact cushion in different depth positions, several fastening points can also be arranged in a row in order to be able to fasten the transverse belt thereto. The impact cushion can also be constructed to be insertable between the side walls of the seat part. Provided for mounting are then, for example, at least at the lower part of the impact cushion, laterally protruding guide projections or guide elements which can be pushed into guide recesses, which extend obliquely from the front top rearwardly to the bottom, or into slot-shaped passages in the side walls of the seat part in a sliding fit. The transverse belt running through the transverse recess in the impact cushion then extends over the upper sides of the side walls of the seat part.

The fastening points at the side walls should be mounted at the outer side. However, constructional solutions are also possible in which at least one fastening point can be mounted on one of the side walls at the inner side.

### BRIEF DESCRIPTION OF THE DRAWINGS

The invention is explained in more detail in the following by way of the embodiments illustrated in the figures.

In the drawings:

FIG. 1 shows, in schematic, simplified illustration, a side view of a child car seat on a vehicle seat with belt systems according to the invention,

FIG. 2 shows a belt system with plug-on securing means,

FIG. 3 shows a belt system with a lock element with lock tongue,

FIG. 4 shows a further embodiment, in which the fastening points for the transverse belt and for the fastening means are arranged separately and

FIG. 5 shows an embodiment with an impact cushion inserted between the side walls of the seat part.

### DETAILED DESCRIPTION OF THE EMBODIMENTS

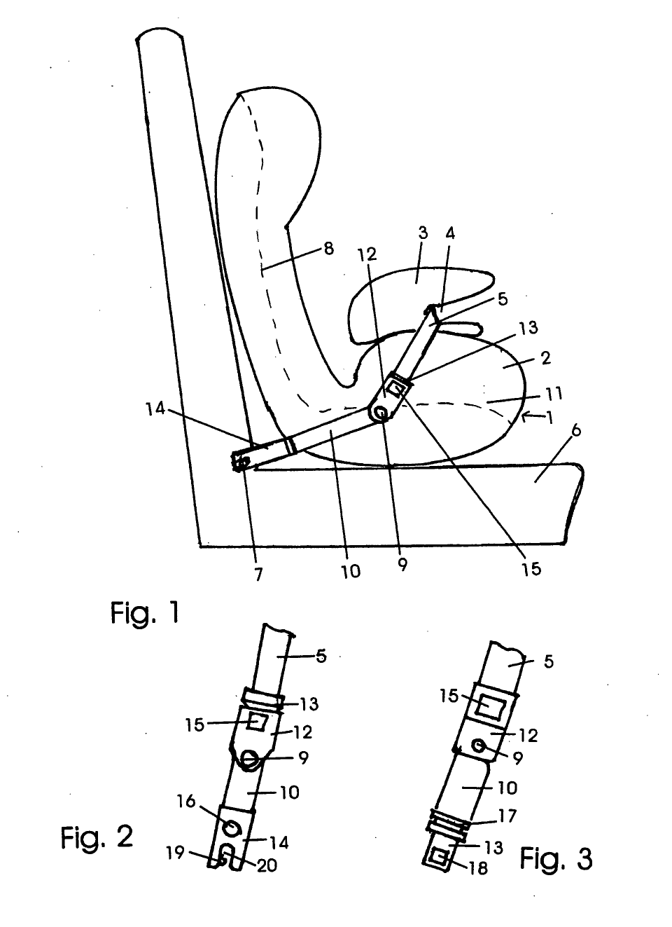

A motor vehicle seat 6 on which a child car seat is placed is illustrated in simplified side view in FIG. 1. This child car seat comprises a seat part 1 and a backrest 8. The backrest 8 is provided with side walls. These are drawn forward in the head region to offer enhanced side impact protection. The seat surface 11 and the back support surface are indicated in dashed lines. The seat part 1 has side walls 2 forming armrests at the upper side. An impact cushion 3 having a recess for reception of a transverse belt 5 is placed on these side walls 2. The impact cushion 3 can have an individual shape, but it has to have a transversely extending recess for reception of the transverse belt. This can also be realised by a slot with an introduction slot through which a transverse belt can be drawn. The design can be left to the manufacturer. In addition, the impact cushion 3 can have lateral guides (not illustrated) guided in guide slots in the side walls 2.

According to the invention, fastening points 9 are now provided at both outer walls 2 at the outer side, for example pins on which lock elements 12 are mounted to be pivotable about the axis. These lock elements 12 are, in the exemplifying embodiment, lock elements of known kind such as used for safety belts, which have an entry gap for reception of a lock tongue at the counter-lock element 13, which is fastened to the transverse belt 5. Disposed in a passage 15 of the lock casing is a button by which unlocking can be undertaken, when this is desired, in order to be able to, for example, pivot the impact cushion 3 away so that the small child can be more easily placed in the seat. Disposed on the other side of the child car seat is an identical arrangement, but alternatively the end of the transverse belt 5 can also be directly fastened to the fastening point 9 (not visible) by means of, for example, an eye, which is placed on the pin, such as a pin with a rivet head, as securing means against being pulled off.

In the event of a crash, introduction of force into the transverse belt 5 and into the fastening points 9 at both sides takes place by way of the impact cushion 3. Each fastening point 9 is additionally connected with a fixing point 7, which is constructed as a transverse pin at the vehicle seat by way of a fastening means 10. In the embodiment, the fastening means 10 similarly consists of a belt which, for example, is plugged by an end by means of a eye onto the pin forming the fastening point 9 and has at the other end a plug-on securing means 14 which can be pushed by a forked recess 20, as apparent from FIG. 2, onto the transverse pin of the fixing point 7 of the vehicle seat. The belt can have a length adjuster. In that case, a catch hook 19 slides over the transverse pin and engages behind this so that the connection is secured. The belt of the fastening means 10 should also be adjustable in length so as to be able to adapt the length to different fixing points in different vehicle types. The described form of connection is illustrated in FIG. 2. Instead of direct fastening of the belt of the fastening means 10 as provided here, an indirect fastening to the fastening point 9, for example by way of a further lock element, can also be effected.

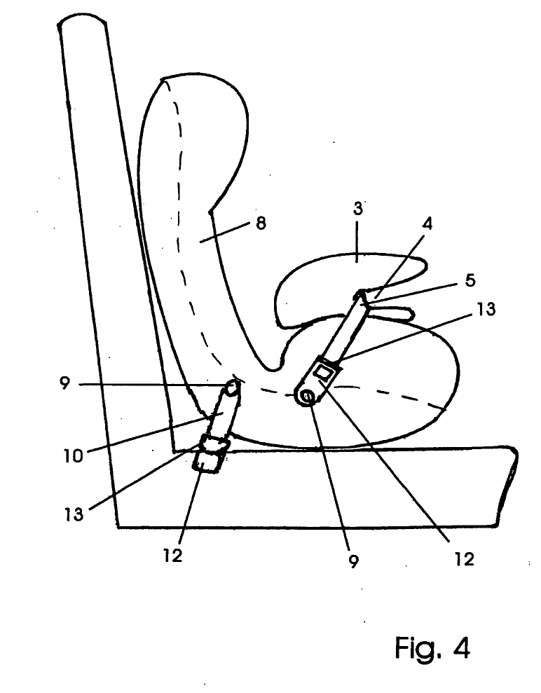

A modification of the embodiment according to FIG. 2 is illustrated in FIG. 3. Clearly apparent in that case is the lock tongue at the lock element 13. This has a recess 18 in which, when pushed into a box-shaped lock element, a detent element engages, the element being actuable by way of a button in the passage 15 (FIG. 1) in order to be able to withdraw the lock tongue from the lock element again. Deflecting means 17 are provided at the end of the belt, which are symbolically illustrated and represent a capability of lengthening or shortening the belt of the fastening means 10. In this embodiment, the same fastening means are provided above the fastening point 9 as in FIGS. 1 and 2 for fixing of the transverse belt 5.

A further embodiment is illustrated in FIG. 4, which differs from that in FIG. 1 in that in each instance two fastening points 9 arranged separately from one another are provided at the child car seat. Whereas the transverse belt 5 is fastenable to one fastening point 9 and detachable by means of the lock elements 12 and 13 provided at both sides at the child car seat, a fastening means 10 in the form of a belt, by means of which a lock element 13 with detent tongue can be inserted into a lock element, is fastened to the other fastening point 9. The second fastening point 9 lies in the lower region of the backrest of the child car seat and is formed by, for example, a transverse pin or a rivet pin or screw bolt. It is apparent from this illustration that in the case of impact the forces acting directly on the child car seat are absorbed by the lower fastening means 10, whilst the forces arising at the impact cushion 3 are introduced exclusively by way of the transverse belt 5 into the front fastening points 9. The fastening points 9 are located, as also in the case of the embodiment in FIG. 1, at both sides of the child car seat.

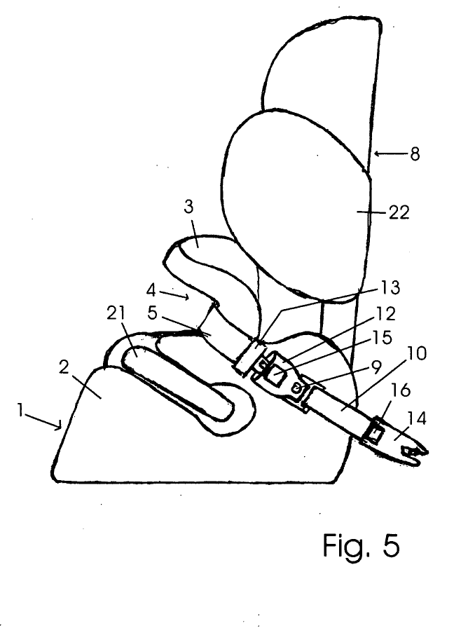

A further embodiment is illustrated in FIG. 5, in which the child safety seat consists of a seat part 1 and an attached backrest element 9, at which shoulder protection parts 22 are mounted in order to protect the upper body against lateral impact. By contrast to the examples in the remaining figures, the impact cushion 3 is constructed so that it is insertable between the two side walls 2 of the seat part 1. For lateral guidance, guide elements 21 are mounted on the lower part of the impact cushion 3 or formed from the foam plastics material body. These guide elements 21 are slidably mounted in slot-shaped passages in the side walls 2 so that a simple adaptation to the size of the child takes place automatically. The impact cushion 3 has a recess 4 in which the transverse belt 5 is guided. The transverse belt 5 has a lock element 13, namely a lock tongue able to be plugged into the lock element 12, which is rotatably fastened to the fastening point 9 at the outer side of the side wall 2. The two interconnected lock elements 12, 13 can thereby automatically orientate in correspondence with the position of the impact cushion 3. In addition, a fastening element for a belt of a fastening means 10, which is provided at the end with a plug-on securing means 14 for plugging onto a transverse pin at the vehicle seat, is pivotably mounted at the fastening point 9. The plug-on securing means 14 can also be constructed so that it receives a lock tongue at the fastening means 10. The fastening means can be removed from the plug-on securing means 14 by way of an unlocking button 16. A button mounted in a passage 15 is similarly provided at the lock element 12 for releasing the connection of the lock element 13 with the lock element 12.

### REFERENCE NUMERAL LIST

1 seat part
2 side wall
3 impact cushion
4 recess
5 transverse belt
6 motor vehicle seat
7 fixing point
8 backrest element
9 fastening point
10 fastening means
11 seat surface
12 lock element
13 lock element
14 plug-on securing means
15 passage
16 unlocking button
17 deflecting means
18 recess
19 catch hook
20 forked opening
21 guide element
22 shoulder protection parts

What is claimed is:

1. A child car seat, comprising:
at least one seat part with side walls forming armrests;
an impact cushion, which is insertable between the side walls of the seat part or placeable thereon and is supported at the side walls, said impact cushion being disposed in front of a child when a child is sitting in the child car seat and having a transversely extending recess;
a transverse belt inserted through said recess;
fastening points located at the two side walls of the seat part; and
a fastener connected to one of the fastening points on each side wall of the seat part to fix the child car seat to a motor vehicle seat; said fastener being adapted to be connected to fixing points at the vehicle seat or at bodywork, wherein said transverse belt is fixed to the seat part at one of the fastening points on each side wall of the seat part.

2. The child car seat according to claim 1, wherein the transverse belt and the fastener are connected to separate fastening points on each of the side walls.

3. The child car seat according to claim 1, wherein at least one of the fastening points on each side wall is disposed in a rearward region below a seat surface or in a lower region of a backrest at an outer side.

4. The child car seat according to claim 1, further comprising at least one plastic or metal lock element or a metal plate fastened to one of the fastening points, and having at least one slot or a retainer for fixing at least one of the fastener and the transverse belt to be pivotable about an axis transverse to a longitudinal axis of the seat part, wherein when said lock element is used, a lock tongue or a lock counter-element corresponding to the lock element is mounted at the transverse belt and is connectable with the lock element by plugging together, and when said metal plate is used, the fastener or the transverse belt is directly fastened to the metal plate.

5. The child car seat according to claim 4, wherein the lock element is attached at one end to the transverse belt and another end is fixed to the fastening point.

6. The child car seat according to claim 4, further comprising deflecting and clamping elements for adjusting a length of the transverse belt, said adjusting and clamping elements being provided at the lock element or offset therefrom.

7. The child car seat according to claim 2, wherein the fastener is a belt and further comprising a lock element provided at one of the fastening points for reception of a lock counter-element at the fastener, and another lock element or a plug-on securing device at another end of the fastener, wherein said plug-on securing device has a forked opening with inserted catch hook that is adapted to be plugged onto a crosspin forming the fixing point, and wherein said another lock element is adapted to be plugged into a counter-lock element, which is provided for a vehicle belt, at the vehicle seat or bodywork.

8. The child car seat according to claim 7, wherein the fastener is adjustable in length by deflecting and clamping retainers or at an adjuster.

9. The child car seat according to claim 4, wherein the lock counter-element is a lock tongue with a recess and the lock element has a detent part, which detents in the recess on insertion of the lock tongue and can be pressed through a passage in a wall of the lock element.

10. The child car seat according to claim 1, wherein there are several fastening points for fixing the impact cushion in different depth positions.

11. The child car seat according to claim 4, wherein one of the fastening points is formed by a rivet or a bolt which is inserted into a passage hole in or at a housing of the lock element and is secured.

12. The child car seat according to claim 1, wherein one of the fastening points is formed by a bracket at the side wall, which bracket forms together with the side wall a gap through which the transverse belt or the fastener is drawn, wherein there is a retraction securing element attached to the transverse belt or the fastener, said retraction securing element preventing drawing back of an end of the transverse belt or fastener, which is led through the gap.

13. The child car seat according to claim 12, wherein the retraction securing element is a lock element of a belt.

14. The child car seat according to claim 1, wherein the fastening point is formed by a bracket at the side wall, which together with the side wall forms a gap, or by an attached eye in which a hook on the transverse belt or fastening means can be hung.
